(19) United States
(12) Patent Application Publication
(10) Pub. No.: US 2025/0103609 A1
(43) Pub. Date: Mar. 27, 2025

(54) System and Method for Managing Data Stored in A Remote Computing Environment

(71) Applicant: The Toronto-Dominion Bank, Toronto (CA)

(72) Inventor: Rajesh UPENDRAN, Kitchener (CA)

(73) Assignee: The Toronto-Dominion Bank, Toronto (CA)

(21) Appl. No.: 18/472,582

(22) Filed: Sep. 22, 2023

(51) Int. Cl. G06F 16/25; G06F 16/28; G06N 20/00

(52) U.S. Cl. CPC G06F 16/254; G06F 16/288; G06N 20/00

(57) ABSTRACT

A system, device and method are provided for managing data ingested into remote computing environments. The illustrative method includes ingesting a first set of data into a first container of a remote computing environment (RCE), the ingesting resulting in a data set structured with structural formatting of the RCE. The method includes determining a functional data model applicable to the ingested data set, and constructing, in the RCE, a relational dataset by at least in part applying the functional data model. The method includes generating a base data set from the ingested data set and the relational data set and persisting the base data set in a second container, the relational data set contributing via one or more tools for accessing relational databases. The method includes returning at least some of the base data set to in response to user requests to access enterprise data.

### TECHNICAL FIELD

The following relates generally to managing data stored in a remote computing environment.

### BACKGROUND

Increasingly, various aspects of society are being digitized. This increased digitization has been accompanied by an increased adoption of cloud computing systems (also known as multi-tenant network environments) to store and read, write, or edit the data stored thereon.

In some instances, data can be ingested into the cloud computing systems and stored in disparate locations. Cloud computing systems have limitations; they may not be suitable or well adapted for ingesting relational databases.

Relational databases, as used in some existing systems, can be important infrastructure components that may be used to avoid overcomplication of existing computing infrastructure, such as requiring extensive customization to be able to serve data intended for a plurality of different uses or users; the unnecessary introduction of latency to serve data according to relationships captured in the relational database; the unnecessary utilization of computing resources to generate functionality that searches different data stores; the unnecessary requirement of expensive expertise to maintain the different computing infrastructure, etc. These issues can compound where large amounts of data are in service in the cloud computing system, or where providing data with low amounts of error or latency is important.

Some cloud computing services' lack of functionality or support for ingesting relational databases can therefore introduce technical challenges to managing data stored in a remote computing environment.

### BRIEF DESCRIPTION OF THE DRAWINGS

Embodiments will now be described with reference to the appended drawings wherein:

FIG. 1 is a schematic diagram of an example computing environment.

FIG. 2 shows a block diagram of a workflow that incorporates an example relation generator 22.

FIG. 3 shows a block diagram of an example configuration of a cloud computing platform.

FIG. 4 shows a block diagram of an example configuration of an enterprise platform.

FIG. 5 shows a block diagram of an example configuration of a user device.

FIG. 6 shows a flow diagram of an example method performed by computer executable instructions for managing data ingested into remote computing environments is shown.

FIG. 7 shows a flow diagram of another example method performed by computer executable instructions for managing data ingested into remote computing environments is shown.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

In some remote computing environments, data lake or lake house architecture is employed, and managing integration of relational type into the environment is challenging. Maintaining data consistency and validating parent-child relationships between entities can be challenging as at least some existing data lake technologies cater to columnar databases which don't support in-built primary key and foreign key relationships. That is, these environments make effectively managing relational data and non-relational or unstructured data in a data lake (or similar) environment difficult. As a result of this impediment, data consistency and required performance is hard to achieve in these environments, whether manually or automatically.

In addition, in at least some existing practices, data sets used for analysis are built by functional languages such as Python or R (e.g., as compared to more accessible extract, transform, load (ETL) tools) to create analytics data sets. These practices result in a siloing of work, and can lead to unnecessary duplication of work, additional use of compute power, complication of maintenance work, etc.

The present disclosure includes a method where a relational database is constructed within the remote computing environment based on one or more functional models. The relational database can be reconstructed after ingestion using structures or models defined by industry standards, structures provided as applicable to certain of the data source(s), etc. The reconstructed relational database can alleviate issues associated with data lake environments that make ingesting relational data difficult.

The creation of the relational database can also result in leveraging more accessible ETL tools for building a base analytics data set and an analytics data set, removing these resulting data sets from silos, and avoiding confusion and segregation of data depending on the users or their purpose (e.g., removing the device between data engineering and machine learning engineering work). In one example, this disclosure contemplates enforcing foreign key (FK) relationships by ETL operations to the relational database reconstructed on the remote computing environment, ensuring that relations are intact by checking the parent-child tables.

In one aspect, a system for managing data ingested into remote computing environments is disclosed. The system includes a processor, a communications module coupled to the processor, and a memory coupled to the processor. The memory stores computer executable instructions that when executed by the processor cause the processor to ingest a first set of data into a first container of a remote computing environment. The ingesting results in an ingested data set which is structured to comply with structural formatting of the remote computing environment. The instructions cause the processor to determine a functional data model applicable to the ingested data set, and construct, in the remote computing environment, a relational dataset by at least in part applying the functional data model to the ingested data set. The instructions cause the processor to generate a base data set from the ingested data set and the relational data set and persist the base data set in a second container of the remote computing environment. The relational data set contributes to the base data set via one or more tools for accessing relational databases. The instructions cause the processor to return at least some of the base data set to in response to user requests to access enterprise data.

In example embodiments, the instructions cause the processor to edit the base data set with one or more transformation tools to generate an analytics data set and provide the analytics data set to a machine learning model training process to train a machine learning model with the analytics data set. An input to the machine learning model is associated with the one or more transformation tools. The instructions can cause the processor to persist the analytics data set in the second container, and provide the analytics data set to requests originating from a first type of authenticated user of a plurality of authenticated users.

The instructions can cause the processor to provide the base data set via a first channel, and provide the analytics data set via a second channel.

The instructions cause the processor to receive a request to train a new model, determine one or more transformation tools responsive to the request to generate the new model, and apply the determined one or more transformation tools to the base data set to generate the analytics data set.

In example embodiments, the instructions cause the processor to edit the base data set with a plurality of transformation tools to generate a plurality of analytics data sets. The plurality of analytics data sets differ from one another by inclusion of at least one feature. The instructions cause the processor to receive a request to access data stored by the remote computing device, and parse the request to determine one or more responsive features. The instructions cause the processor to determine analytics data sets of the plurality of analytics data sets responsive to the one or more responsive data features, and return the determined analytics data sets in response to the request.

The request can be a request to train a machine learning model or a request to generate a new intelligence data set.

The instructions can cause the processor to integrate the relational dataset with the analytics data set in a third container of the remote computing system, the third container serving data to requests via a third channel. The integration can generate a third container that incorporates structured and unstructured data.

The second container can provides data for real time analytics.

In another aspect, a method for managing data ingested into remote computing environments is disclosed. The method includes ingesting a first set of data into a first container of a remote computing environment, the ingesting resulting in an ingested data set which is structured to comply with structural formatting of the remote computing environment. The method includes determining a functional data model applicable to the ingested data set, and constructing, in the remote computing environment, a relational dataset by at least in part applying the functional data model to the ingested data set. The method includes generating a base data set from the ingested data set and the relational data set and persisting the base data set in a second container of the remote computing environment. The relational data set contributes to the base data set via one or more tools for accessing relational databases. The method includes returning at least some of the base data set to in response to user requests to access enterprise data.

In example embodiments, the method includes editing the base data set with one or more transformation tools to generate an analytics data set, and providing the analytics data set to a machine learning model training process to train a machine learning model with the analytics data set, an input to the machine learning model being associated with the one or more transformation tools.

The method can include persisting the analytics data set in the second container, and providing the analytics data set to requests originating from a first type of authenticated user of a plurality of authenticated users.

The method can include providing the first set of data via a first channel, and providing the base data set via a second channel.

The method can include receiving a request to train a new model, determining one or more transformation tools responsive to the request to generate the new model, and applying the determined one or more transformation tools to the base data set to generate the analytics data set.

In example embodiments, the method can include editing the base data set with a plurality of transformation tools to generate a plurality of analytics data sets, the plurality of analytics data sets differing from one another by inclusion of at least one feature, and receiving a request to access data stored by the remote computing device. The method can include parsing the request to determine one or more responsive features, determining analytics data sets of the plurality of analytics data sets responsive to the one or more responsive data features, and returning the determined analytics data sets in response to the request.

The request can be a request to train a machine learning model or a request to generate a new intelligence data set.

The method can include integrating the relational dataset with the analytics data set in a third container of the remote computing system, the third container serving data to requests via a third channel. The second container can provide data for real time analytics.

In another aspect, a non-transitory computer readable medium (CRM) for managing data ingested into remote computing environments is disclosed. The CRM includes computer executable instructions for ingesting a first set of data into a first container of a remote computing environment, the ingesting resulting in an ingested data set which is structured to comply with structural formatting of the remote computing environment, and determining a functional data model applicable to the ingested data set. The instructions are for constructing, in the remote computing environment, a relational dataset by at least in part applying the functional data model to the ingested data set, and generating a base data set from the ingested data set and the relational data set and persisting the base data set in a second container of the remote computing environment, the relational data set contributing to the base data set via one or more tools for accessing relational databases. The instructions are for returning at least some of the base data set to in response to user requests to access enterprise data.

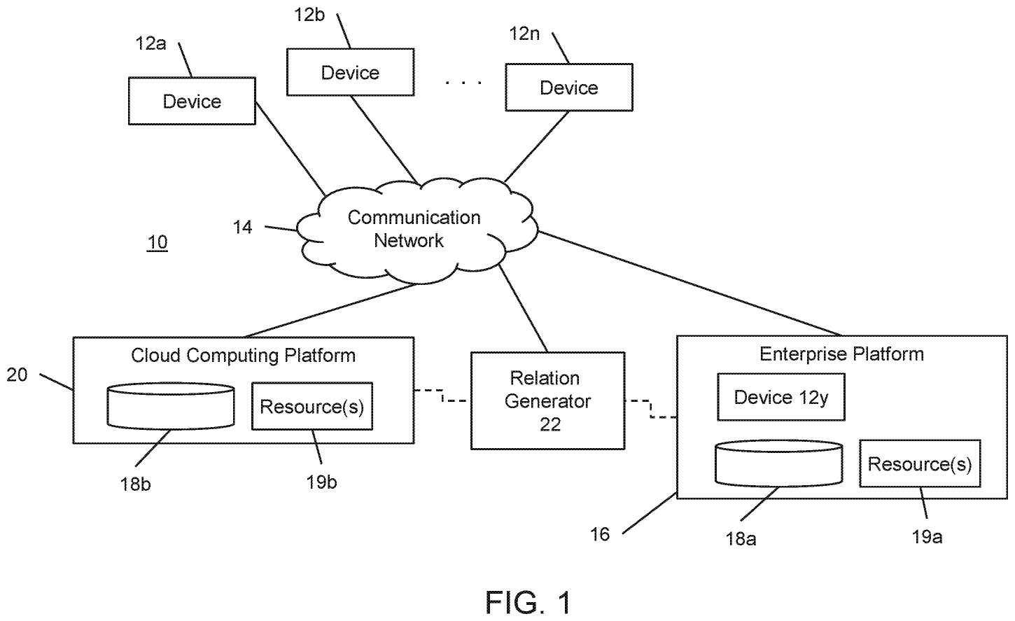

FIG. 1 illustrates an exemplary computing environment 10. The computing environment 10 can include one or more devices 12 for interacting with computing devices or elements implementing an ingestion process (as described herein), a communications network 14 connecting one or more components of the computing environment 10, an enterprise platform 16, and a cloud computing platform 20.

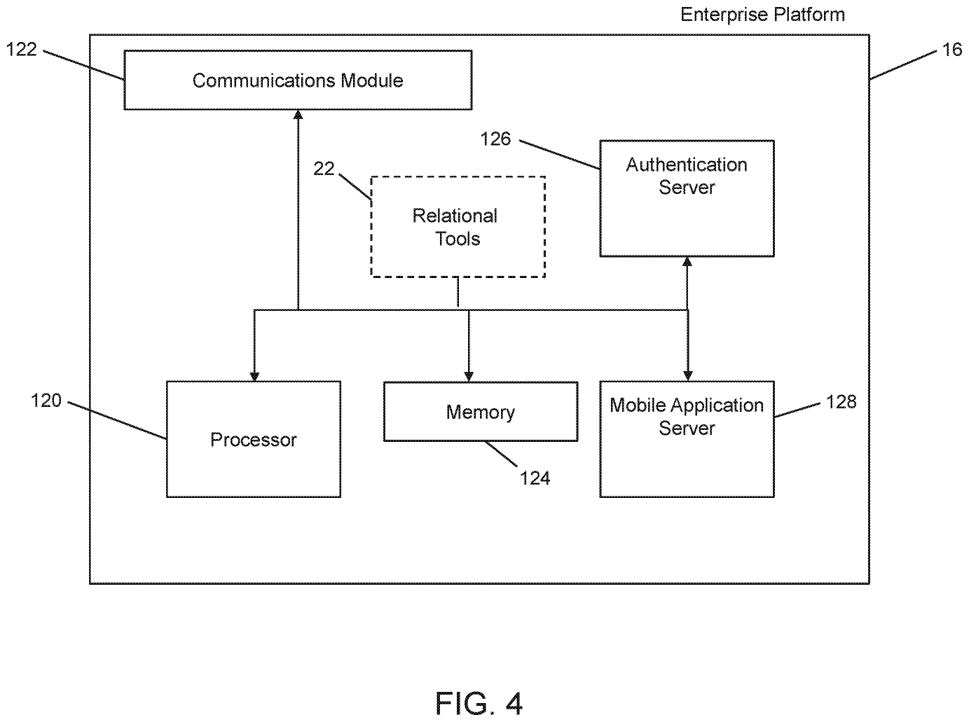

The enterprise platform 16 (e.g., a financial institution such as commercial bank and/or lender) stores data (in the shown example stored in a database 18a) that is to be ingested into the cloud computing platform 20. For example, the enterprise platform 16 can provide a plurality of services via a plurality of enterprise resources (e.g., various instances of the shown database 18a, and/or computing resources 19a). While several details of the enterprise platform 16 have been omitted for clarity of illustration, reference will be made to FIG. 4 below for additional details.

The enterprise platform 16 can be responsible for at least in part sensitive data (e.g., financial data, customer data, etc.), data that is not sensitive, or a combination of the two. This disclosure contemplates an expansive definition of data that is not sensitive, including, but not limited to factual data (e.g., environmental data), data generated by an organization (e.g., monthly reports, etc.), etc. This disclosure contemplates an expansive definition of data that is sensitive, including client data, personally identifiable information, financial information, medical information, trade secrets, confidential information, etc.

The enterprise platform 16 includes resources 19a to facilitate ingestion. For example, the enterprise platform 16 can include a communications module (e.g., module 122 of FIG. 4) to facilitate communication with the relation generator 22 or cloud computing platform 20.

The cloud computing platform 20 similarly includes one or more instances of a database 18b (alternatively referred to as containers), for example, for receiving data to be ingested, for storing ingested data, for storing generated data sets, models, etc. Resources 19b of the cloud computing platform 20 can facilitate the creation of and storage of data sets, the application of one or more tools (e.g., transformation or modelling tools) to data stored, the training of models (machine learning or otherwise), etc. Hereinafter, for ease of reference, the resources 18, 19, of the respective platform 16 or 20 shall be referred to generally as resources, unless otherwise indicated.

Devices 12 may be associated with one or more users. Users may be referred to herein as customers, clients, users, investors, depositors, correspondents, or other entities that interact with the enterprise platform 16 and/or cloud computing platform 20 (directly or indirectly). The computing environment 10 may include multiple devices 12, each device 12 being associated with a separate user or associated with one or more users. The devices can be external to the enterprise system (e.g., the shown devices 12a, 12b, to 12n, with which clients provide sensitive data to the enterprise), or internal to the enterprise platform 16 (e.g., the shown device 12y, which can be controlled by a data scientist of the enterprise). In certain embodiments, a user may operate device 12 such that device 12 performs one or more processes consistent with the disclosed embodiments. For example, the user may use device 12 to request the generation of an analytics data set on the cloud computing platform 20, to transfer data from the database 18a to the cloud computing platform 20, to request training of a model, etc.

Devices 12 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

The cloud computing platform 20 and/or enterprise platform 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the cloud computing platform 20 and enterprise platform 16. The cryptographic server may, for example, be used to protect any data of the enterprise platform 16 when in transit to the cloud computing platform 20, or within the cloud computing platform 20 (e.g., data such as financial data and/or client data and/or transaction data within the enterprise) by way of encryption for data protection, digital signatures or message digests for data integrity, and by using digital certificates to authenticate the identity of the users and devices 12 with which the enterprise platform 16 and/or cloud computing platform 20 communicates with (e.g., requests). It can be appreciated that various cryptographic mechanisms and protocols can be chosen and implemented to suit the constraints and requirements of the particular deployment of the cloud computing platform 20 or enterprise platform 16 as is known in the art.

The environment 10 includes a relation generator 22 for facilitating ingestion of data stored on the enterprise platform 16 to the cloud computing platform 20, and more particularly for generating and/or utilizing a relational database within the cloud computing platform 20. The relation generator 22 can have a variety of aspects: the generator 22 can be used to generate a relational database, the generator 22 can be used to integrate a relational database into workflows that focus on unstructured data, the generator 22 can be used to generate additional datasets from relational databases, etc.

It can be appreciated that while the relation generator 22, cloud computing platform 20 and enterprise platform 16 are shown as separate entities in FIG. 1, they may also be utilized at the direction of a single party. For example, the cloud computing platform 20 can be a service provider to the enterprise platform 16, such that resources of the cloud computing platform 20 are provided for the benefit of the enterprise platform 16. Similarly, the relation generator 22 can originate within the enterprise platform 16, as part of the cloud computing platform 20, or as a standalone system provided by a third party.

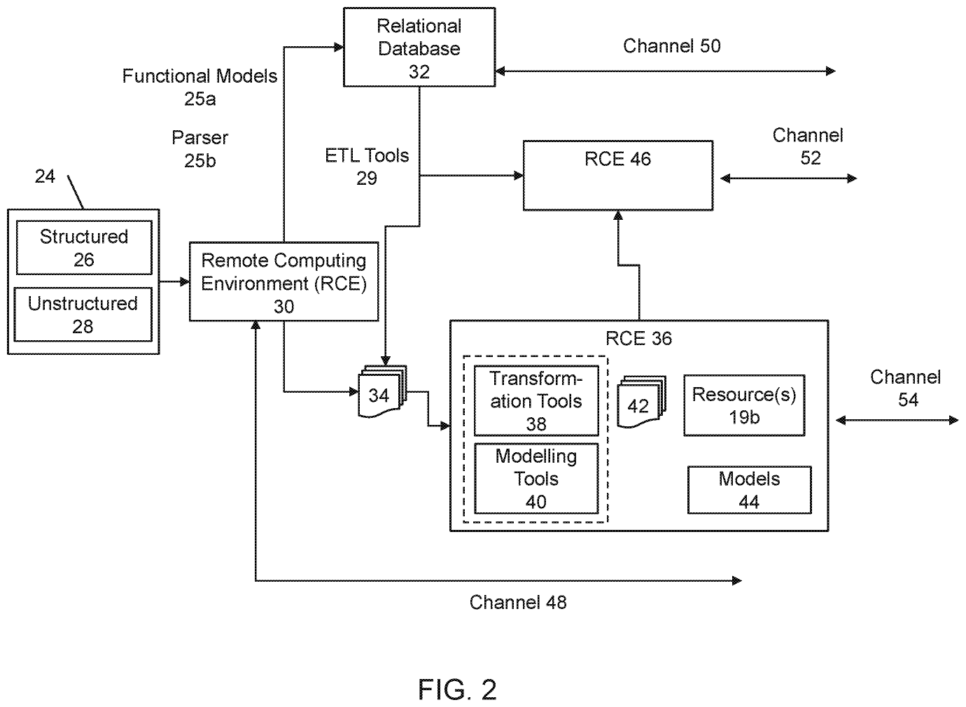

FIG. 2 shows a block diagram of a workflow that incorporates an example relation generator 22.

As shown in FIG. 2, a first set of data (referred to hereinafter as data set 24, for ease of reference), is ingested into a remote computing environment container 30 (hereinafter referred to as a first container 30, for ease of reference). The data set 24 can include structured data, shown as structured data 26, and unstructured data, shown as unstructured data 28. Structured data 26 can include data that explicitly maps interrelations between different data. For example, structured data can include a series of invoices related to a project, where the structured data includes explicit information documenting the relationship of the invoice and the project.

Unstructured data 28 can include data that does not include explicit relationships. For example, unstructured data 28 can include images, audio files, portable document format files (PDFs), etc.

The first container 30 can be container for storing so-called raw data files from an enterprise system 16. That is, the data received from the enterprise system 16 can be required to comply with structural formatting of the container 30 via the process of ingesting the data into the first container 30, where the structural formatting of the container 30 is not conducive to ingesting relational data. For example, the relational nature can be lost in part when the data is ingested in blobs.

The raw data files stored on the first container 30 can include the ingested first data set 24, or other data sets from the plurality of databases 18a of the enterprise system 16, etc. For clarity, this disclosure focuses on processes where ingesting raw data into the first container 30 results in the first data 24 being at least in part converted to structural formatting of the container 30 such that at least some of the structured data 26 becomes unstructured upon being ingested.

As described herein, in an example embodiment, a relational database 32 can be reconstructed with the ingested data set 24. The relational database 32 recaptures the structure lost as a result of the ingestion of the structured data 26.

The relational database 32 can be generated with one or more functional models 25a, and one or more parsers 25b. It is understood that the shown embodiment is illustrative, and that one functional model 25a can be used, or various combinations of models 24a and parsers 25b are used, etc.

The functional models 25a can be applied to data in first container 30 to generate the relational database 32. The functional models 25a can include, for example, one or more models based on standards employed within an industry. For example, the standards can be based on the Financial Services Data Model (FSDM), the Banking Industry Architecture Network (BIAN), etc. The functional models 25a can be based on proprietary standards of the enterprise system 16, such as a data structure used by the enterprise system 16 to track invoices, etc.

One or more parsers 25b can be used to determine which functional model 25a is applied to data in the first container 30. In example embodiments, the parser 25b is used to trawl through all data being ingested in the first container 30 (alternatively referred to as the bronze level), and determine if the data corresponds to one to more functional models 25a. For example, the parser 25b can be used to determine that incoming data includes one, some, or all data fields identified as inputs to the functional model 25 (e.g., the data includes an invoice number, an invoice amount, etc.). In example embodiments, the parser 25b is used to search for data from different data sources 18a, and apply a functional model 25a assigned to data from a particular data source.

The functional models 25a apply one or more transformations to the ingested data file 24 to impose relations between data to generate the relational database 32. For example, the data can re-structure the ingested data file 24 into a database, such as a SQL database.

The relational database 32 and the ingested data file 24 can be used to generate a base data set 34. The base data set 34 can be generated using extract, transform, and load (ETL) operations, shown as ETL tools 29, (e.g., to data in the database 32), including but not limited to ADS, informatica, and Data Bricks based techniques. The base data set 34 can therefore include the relational data from the relational database 32, and the unstructured data within the first container 30.

For visual clarity the base data set 34 is shown outside of the second container 36 (alternatively referred to as the silver layer), and it is understood that the base data set 34 can be persisted in the second container 36.

The base data set 34 can be processed by one or more of the transformation tools 38 and/or the modelling tools 40 to generate an analytics data set 42. The transformation tools 38 can include tools to ensure that the ingested data is in a data structure that is used for analysis. For example, the transformation tools 38 can be used to remove data which is associated with null values, etc. The transformation tools 38 can include tools that implement feature transformations such as principal component analysis (PCA) transformations, neighborhood component analysis (NCA) analysis, FA based analysis, etc. The tools 38 can include normalization tools.

The modelling tools 40 can be used to generate or impart one or more features or characteristics into the analytics data set 42. For example, the modelling tools 40 can include tools to serialize or deserialize data. The modelling tools 40 can include tools to create dummy variables, or to employ conversions of the data such as one hot encoding techniques, etc.

The modelling tools 40 can be used to prepare the base data set 34 for processing by a machine learning training process. For example, one or more models 44 may be embodied as machine learning models intended to be trained using the base data set 34, but each model may require a different format of data to be input, or different aspects of the base data set 34. For example, one model 44 can be more attuned to serialized trends, and as a result the base data set 34 can be processed with the tools 40 to generate an analytics data set 42 with serialized data. In another example, the data set 34 can include a certain categorical data whereas the model 44 can be intended to process only integers, and as a result the base data set 34 can be processed with the tools 40 to generate an analytics data set 42 with categorical variable conversion.

An instance of the resources 19b, shown in FIG. 2, can be used to generate the analytics data set 42, the base data set 34, to train the models 44, etc.

The models 44 can include a variety of different models, including machine learning models, statistical models, etc. The models 44 can be models created by third parties, existing models, bespoke models, a combination of a plurality of models, etc.

The models 44 can be used to process the base data sets 34 or the analytics data sets 42 to generate one or more model influenced data sets (not shown). These model influenced data sets can include new features generated by the models 44 after processing. For example, the model influenced models 44 can be used to generate a new data set that summarizes various data, such as different product sales, into categories.

The trained models 44 can be deployed in the second container 36. The trained models 44 can, for example, be used to deploy a model output webservice, registered with a pickle file, deployed to an Azure Kubernetes Service (AKS) cluster, etc.

One, some, or all of the raw data, the base analytics data set 34, analytics data 42, or the model influenced data set, or a combination (where the term combination denotes combinations where none of a particular data is included) can be provided to the remote computing environment 46. The remote computing environment 46 can alternatively be referred to as a gold storage layer or a third container 46. In at least some example embodiments, the base analytics data set 34 is provided to the third container 46, and the other data sets are persisted in the second container 36.

Data from the second container 36 to be stored in the third container 46 can be integrated with data from the relational database 32, via the ETL tools 29. For example, where the data from the second container 36 is an analytics data set 42 of certain financial transactions that resulted from a call center, the third container 46 can be populated with the analytics data set 42 and audio data stored in the relational database 32 related to the calls described in the analytics data set 42. In another example, the data from the second container 36 can be a model influenced data set that can include a variety of transactions that are deemed suspicious. The relational database 32 can provide emails between users and enterprise staff associated with the identified transactions to enable a more rapid security review. In another example, where the data in the second container 36 is a base data set 34 that includes a description of customer complaints, and the relational database 32 can provide related images of handwritten customer complaints.

Each of the containers 30, 36, 46, and the relational database 32 can be connected to separate channels to serve the data stored thereon. In the shown embodiment a first channel 48 is used to view the raw data stored in the first container 30. Channel 48 can be a dedicated channel which enables only certain credentialed users, such as data scientist staff, the ability to access the data stored thereon. These users can be prohibited from changing the data in the first container 30. In contrast, administrators can be credentialed to adjust one or more operating parameters of the first container 30, such maintaining access to different functional models 25a or parsers 25 b. These administrators can be provided with yet another channel (not shown).

Channel 54 can be a channel configured with permission to enable real time analytics users to interact with the base data set 34 in the second container 36. For example, channel 54 can be used to train models, to generate tools used to generate analytics models, etc. This channel can be provided with the ability to access large amounts of resources 19b to enable the operations discussed herein.

In at least some example embodiments, the channel 54 can include an application programming interface (API) to interact with the trained models 44. For example, once a model 44 has been trained on data in the second container, the model 44 can be deployed via an API and provide its output via the channel 54.

Channel 52 can be used to enable users to view data stored in the third container 46. As the data in the third container 46 can be considered the gold level data, channel 52 can be used to provide data in instances where accuracy and curation are most important. For example, the channel 52 can be used to provide data to business users, and to customers or other self-serve users. The provided data can be summarized and curated data, and data that integrates model 44 outputs (e.g., where model influenced data sets are persisted in the third container 46).

Channel 50 can be used to serve users who are conformable operating with relational databases, and therefore the relational database 32 can operate as a backwards compatible implementation in a remote computing environment.

The relational tools 22 can include or comprise combinations of the various tools or functionality shown in FIG. 2. For example, the relational tools 22 can include the transformation tools 38, the ETL tools 29, and the modelling tools 40. In example embodiments, the relational tools 22 can include the functional models 25a, and the parser 25b.

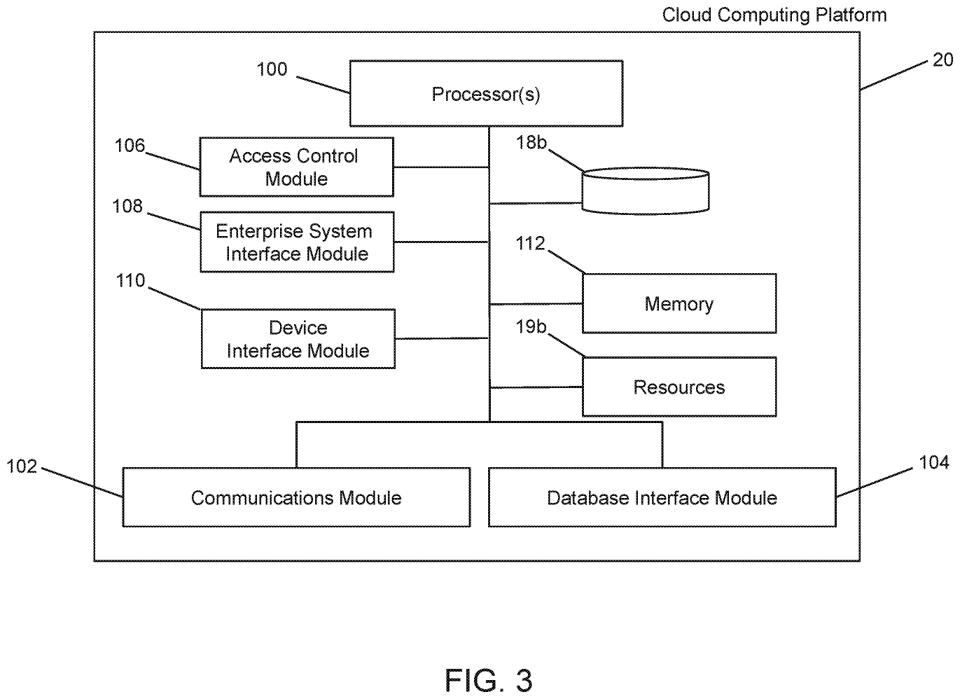

Referring now to FIG. 3, a block diagram of an example configuration of a cloud computing platform 20 is shown. FIG. 3 illustrates examples of modules, tools and engines stored in memory 112 on the cloud computing platform 20 and operated or executed by the processor 100. It can be appreciated that any of the modules, tools, and engines shown in FIG. 3 may also be hosted externally and be available to another cloud computing platform 20, e.g., via the communications module 102.

In the example embodiment shown in FIG. 3, the cloud computing platform 20 includes an access control module 106, an enterprise system interface module 108, a device interface module 110, and a database interface module 104. The access control module 106 may be used to apply a hierarchy of permission levels or otherwise apply predetermined criteria to determine what aspects of the cloud computing platform 20 can be accessed by devices 12, what resources 18b, 19b, the platform 20 can provide access to, and/or how related data can be shared with which entity in the computing environment 10. For example, the cloud computing platform 20 may grant certain employees of the enterprise platform 16 access to only certain resources 18b, 19b, but not other resources. In another example, the access control module 106 can be used to control which users are permitted to generate analytics data models 42, or change access permissions or establish channels, etc. As such, the access control module 106 can be used to control the sharing of resources 18b, 19b or aspects of the platform 20 based on a type of client/user, a permission or preference, or any other restriction imposed by the enterprise platform 16, the computing environment 10, or application in which the cloud computing platform 20 is used.

The enterprise system interface module 108 can provide a graphical user interface (GUI), software development kit (SDK) or API connectivity to communicate with the enterprise platform 16. It can be appreciated that the enterprise system interface module 108 may also provide a web browser-based interface (e.g., to engage with the model output webservice of channel 54), an application or “app” interface, a machine language interface, etc. Similarly, the device interface module 110 can provide a graphical user interface (GUI), software development kit (SDK) or API connectivity to communicate with devices 12. The database interface module 104 can facilitate direct communication with database 18a, or other instances of database 18 stored on other locations of the enterprise platform 16.

In FIG. 4, an example configuration for an enterprise platform 16 is shown. In certain embodiments, similar to the cloud computing platform 20, the enterprise platform 16 may include one or more processors 120, a communications module 122, and a database interface module (not shown) for interfacing with the remote or local datastores to retrieve, modify, and store (e.g., add) data to the resources 18a, 19a. Communications module 122 enables the enterprise platform 16 to communicate with one or more other components of the computing environment 10, such as the cloud computing platform 20 (or one of its components), via a bus or other communication network, such as the communication network 14. The enterprise platform 16 can include at least one memory or memory device 124 that can include a tangible and non-transitory computer-readable medium having stored therein computer programs, sets of instructions, code, or data to be executed by processor 120. FIG. 4 illustrates examples of modules, tools and engines stored in memory on the enterprise platform 16 and operated or executed by the processor 120. It can be appreciated that any of the modules, tools, and engines shown in FIG. 4 may also be hosted externally and be available to the enterprise platform 16, e.g., via the communications module 122. In the example embodiment shown in FIG. 4, the enterprise platform 16 includes at least part of the relation generator 22 (e.g., to automate ingestion of structured data and generation of the relational database), an authentication server 126, for authenticating users to access resources 18a, 19a, of the enterprise, and a mobile application server 128 to facilitate a mobile application that can be deployed on mobile devices 12. The enterprise platform 16 can include an access control module (not shown), similar to the cloud computing platform 20.

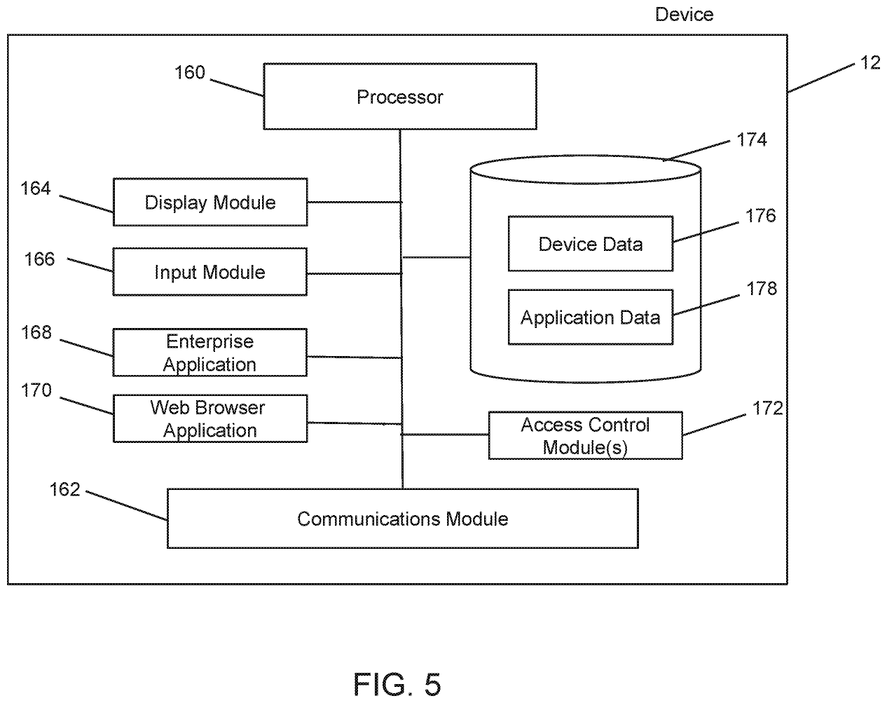

In FIG. 5, an example configuration of a device 12 is shown. In certain embodiments, the device 12 may include one or more processors 160, a communications module 162, and a data store 174 storing device data 176 (e.g., data needed to authenticate with a cloud computing platform 20 to perform ingestion), an access control module 172 similar to the access control module of FIG. 4, and application data 178 (e.g., data to enable communicating with the enterprise platform 16 to enable transferring of database 18a to the cloud computing platform 20). Communications module 162 enables the device 12 to communicate with one or more other components of the computing environment 10, such as cloud computing platform 20, or enterprise platform 16, via a bus or other communication network, such as the communication network 14. While not delineated in FIG. 5, similar to the cloud computing platform 20 the device 12 includes at least one memory or memory device that can include a tangible and non-transitory computer-readable medium having stored therein computer programs, sets of instructions, code, or data to be executed by processor 160. FIG. 5 illustrates examples of modules and applications stored in memory on the device 12 and operated by the processor 160. It can be appreciated that any of the modules and applications shown in FIG. 5 may also be hosted externally and be available to the device 12, e.g., via the communications module 162.

In the example embodiment shown in FIG. 5, the device 12 includes a display module 164 for rendering GUIs and other visual outputs on a display device such as a display screen, and an input module 166 for processing user or other inputs received at the device 12, e.g., via a touchscreen, input button, transceiver, microphone, keyboard, etc. The device 12 may also include an enterprise application 168 provided by the enterprise platform 16, e.g., for submitting requests to transfer data from the database 18a to the cloud. The device 12 in this example embodiment also includes a web browser application 170 for accessing Internet-based content, e.g., via a mobile or traditional website and one or applications (not shown) offered by the enterprise platform 16 or the cloud computing platform 20. The data store 174 may be used to store device data 176, such as, but not limited to, an IP address or a MAC address that uniquely identifies device 12 within environment 10. The data store 176 may also be used to store authentication data, such as, but not limited to, login credentials, user preferences, cryptographic data (e.g., cryptographic keys), etc.

It will be appreciated that only certain modules, applications, tools, and engines are shown in FIGS. 3 to 5 for ease of illustration and various other components would be provided and utilized by the cloud computing platform 20, enterprise platform 16, and device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in cloud computing platform 20 or enterprise platform 16, or device 12, or accessible or connectable thereto. Any application or module herein described may be implemented using computer readable/executable instructions that may be stored or otherwise held by such computer readable media.

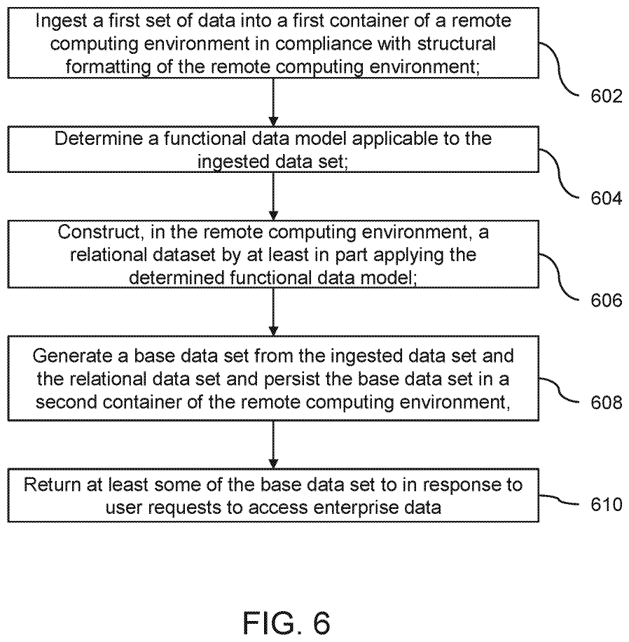

Referring to FIG. 6, a flow diagram of an example method performed by computer executable instructions (e.g., stored on a memory as described in FIGS. 3-5) for managing data ingested into remote computing environments is shown. It is understood that the method shown in FIG. 6 may be automatically completed in whole, or only part of the blocks shown therein may be completed automatically (e.g., the functionality of the relation generator 22). Furthermore, it is understood that references in FIG. 6 to elements of the preceding figures in this application are illustrative and are not intended to be limiting.

At block 602, a first data set (e.g., data set 24) is ingested into a first container (e.g., container 30) of a remote computing environment (e.g., cloud computing environment 20). The ingestion of the first data set 24 into the container 30 results in an ingested data set which is structured to comply with structural formatting of the container 30, and may not retain the relational data initially in the structured data 26. For example, data which was previously structured may be ingested in an unstructured manner, or structured data used to link together various unstructured data can be stripped of its linking features.

At block 604, a functional data model (e.g., functional model 25a) applicable to the ingested data set (e.g., data stored in the first container 30) is determined. The functional data model can be determined based on the source of data, based on the content of the data in the first container 30, based on an industry standard, etc.

At block 606, a relational database (e.g., relational database 32) is constructed in the remote computing environment. The relational data set 22 is constructed at least in part by applying the determined functional data model of block 604 to the ingested data set.

At block 608, a base data set (e.g., base data set 34) is generated from the ingested data set (e.g., data in the first container 30) and the relational database. The base data set is persisted in a second container (e.g., container 36) of the remote computing environment. In example embodiments, the relational database contributes to the base data set via one or more tools (e.g., ETL tools) for accessing relational databases.

At block 610, at least some of the base data set is served in response to a user request to access data stewarded by the enterprise platform 16.

It is understood that the sequence shown in FIG. 6 is illustrative, and not limiting. For example, a functional data model applicable to the ingested data set can be determined before the data set is ingested (e.g., via a configuration in the data source).

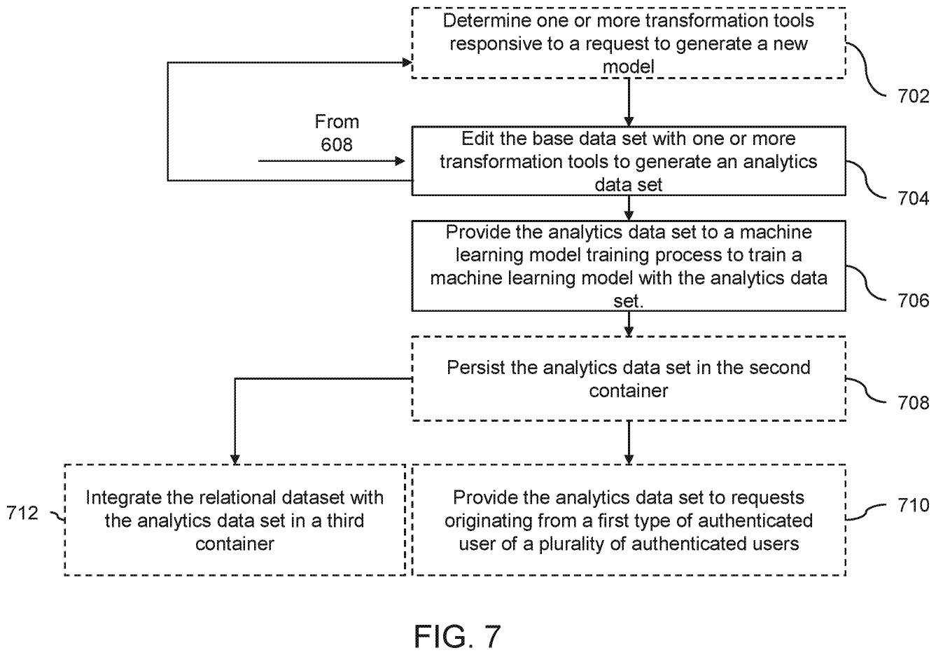

Referring to FIG. 7, a flow diagram of another example method performed by computer executable instructions (e.g., stored on a memory as described in FIGS. 3-5) for managing data ingested into remote computing environments is shown.

At block 702, one or more transformation tools (e.g., transformation tools 38, modeling tools 40, etc.) responsive to a request to generate a new machine learning model (e.g., model 44) are determined. The determination can be the result of a user input (e.g., received via channel 54), and automated process resulting from a new version of a base data set 34 being provided to the second container 36, a result of the parser 25b determining related tools, etc.

At block 704, the base data set (e.g., base data set 34), is edited with the tools determined in block 702 to generate an analytics data set (e.g., data set 42). The base data set can be the base data set generated in block 608, as shown. The analytics data sets generated in block 704 can be edited at least in part to promote reusability. For example, the tools can be one or more anonymizing tools, and the analytics data set 42 can be a data set stripped of all identifying information. This analytics data set may be used as a building block to generate more analytics data sets, providing a new standard data set for analysis where personal data is not needed.

As alluded to above, and is shown in FIG. 7, a plurality of different analytics data sets can be generated based on the base data sets 34 or based on existing analytics data sets 42. In at least some example embodiments, a plurality of different tools 38, 40 for a plurality of different use cases can be applied to the base data set 34, the plurality of analytics or base data sets differing from one another by the inclusion of at least one different feature, different data structure, different content, etc. For example, an aggregate analytics data set 42 can be generated automatically at the end of quarter. An anonymized analytics data set can be periodically updated with certain tools 38, 40. Different analytics data sets 42 can be generated for different lines of business (e.g., a credit card data set, a retail branch data set, etc.). Similarly, derivative analytics data sets can be generated with the tools 38, 40. For example, the aggregate analytics data set described above can be an input to a tool 40 to model market performance implied in the aggregate data set. In another example, the anonymized analytics data set can be automatically used as an input to a tool 40 to generate a customer satisfaction analytics data set.

The tools used to generate the analytics data set 42 can be responsive to one or more models 44. That is, the tools can be configured to process the data such that the analytics data set 42 complies with one or more requirements to train one or more models 44. For example, the tools can be used to generate analytics data sets for large language models (i.e., input is a string), etc.

At block 706, the analytics data set is provided to a machine learning model training process to train a machine learning model 44 with the analytics data set 42. In this way, collectively block 702, 704, and 706, can generate data sets, and related features (e.g., resulting from the model 44, or the tools 38, 40), to initiate training of a variety of different machine learning models in an open and transparent manner.

The block 708, the generated analytics data set can be persisted in the second container 36. As the data sets are stored in the second container 36, the various base and analytics data sets can be incorporated into workflows of many different users. For example, specialized functional software for generating data sets which may be opaque to other users can be avoided. Similarly, reuse of data curation and feature learning can occur as these data sets can be re-used. For example, the anonymized data set created by a data scientist can be reused by a variety of users.

At block 710, the analytics data sets generated in block 704 can be served to request originating from a first type of authenticated user of a plurality of authenticated users. For example, channel 54 can be used to serve analytics data sets to all data scientist users accessing the second container 36. In this way, transparency is enforced, and data scientists can reuse data sets for different applications. Similarly, the channel 54 can also accommodate machine learning engineer users, ensuring that machine learning engineers work is not duplicated (e.g., a model 44 is used to generate a new feature), and ensuring that these engineers are provided with the best curated data available.

A block 712, the analytics data set, along with at least some data from the relational database 32, can be integrated into the third container 46. For example, block 712 can be used to populate the third container 46, while incorporating any insights received by the models 44, or generated by the tools 38, 40. It is understood that the dashed blocks in FIG. 7 are optional.

The generation of a base data set and an analytics data set may advantageously allow for extensibility of the disclosed architecture. For example, the base data set can be served to data scientists via the first channel 48, to enable them to perform real-time analysis on raw data, while simultaneously the analytics data set 42 can be provided via the channel 54 to machine learning engineers. Different users using different channels, while the output of their actions is transparent within the second container 36, can result in more careful management of responsibilities, and facilitate simultaneous use.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for managing data ingested into remote computing environments, the system comprising:
a processor;
a communications module coupled to the processor; and
a memory coupled to the processor, the memory storing computer executable instructions that when executed by the processor cause the processor to:
ingest a first set of data into a first container of a remote computing environment, the ingesting resulting in an ingested data set which is structured to comply with structural formatting of the remote computing environment;
determine a functional data model applicable to the ingested data set;
construct, in the remote computing environment, a relational dataset by at least in part applying the functional data model to the ingested data set;
generate a base data set from the ingested data set and the relational data set and persist the base data set in a second container of the remote computing environment, the relational data set contributing to the base data set via one or more tools for accessing relational databases; and
return at least some of the base data set to in response to user requests to access enterprise data.

2. The system of claim 1, wherein the instructions cause the processor to:
edit the base data set with one or more transformation tools to generate an analytics data set; and
provide the analytics data set to a machine learning model training process to train a machine learning model with the analytics data set, an input to the machine learning model being associated with the one or more transformation tools.

3. The system of claim 2, wherein the instructions cause the processor to:
persist the analytics data set in the second container; and
provide the analytics data set to requests originating from a first type of authenticated user of a plurality of authenticated users.

4. The system of claim 2, wherein the instructions cause the processor to:
provide the base data set via a first channel; and
provide the analytics data set via a second channel.

5. The system of claim 2, wherein the instructions cause the processor to:
receive a request to train a new model;
determine one or more transformation tools responsive to the request to generate the new model; and
apply the determined one or more transformation tools to the base data set to generate the analytics data set.

6. The system of claim 1, wherein the instructions cause the processor to:
edit the base data set with a plurality of transformation tools to generate a plurality of analytics data sets, the plurality of analytics data sets differing from one another by inclusion of at least one feature;
receive a request to access data stored by the remote computing device;
parse the request to determine one or more responsive features;
determine analytics data sets of the plurality of analytics data sets responsive to the one or more responsive data features; and
return the determined analytics data sets in response to the request.

7. The system of claim 6, wherein the request is a request to train a machine learning model or a request to generate a new intelligence data set.

8. The system of claim 2, wherein the instructions cause the processor to:
integrate the relational dataset with the analytics data set in a third container of the remote computing system, the third container serving data to requests via a third channel.

9. The system of claim 8, wherein the integration generates a third container that incorporates structured and unstructured data.

10. The system of claim 1, wherein the second container provides data for real time analytics.

11. A method for managing data ingested into remote computing environments, the method comprising:
ingesting a first set of data into a first container of a remote computing environment, the ingesting resulting in an ingested data set which is structured to comply with structural formatting of the remote computing environment;
determining a functional data model applicable to the ingested data set;
constructing, in the remote computing environment, a relational dataset by at least in part applying the functional data model to the ingested data set;
generating a base data set from the ingested data set and the relational data set and persisting the base data set in a second container of the remote computing environment, the relational data set contributing to the base data set via one or more tools for accessing relational databases; and
returning at least some of the base data set to in response to user requests to access enterprise data.

12. The method of claim 11, comprising:
editing the base data set with one or more transformation tools to generate an analytics data set; and
providing the analytics data set to a machine learning model training process to train a machine learning model with the analytics data set, an input to the machine learning model being associated with the one or more transformation tools.

13. The method of claim 12, further comprising:
persisting the analytics data set in the second container; and
providing the analytics data set to requests originating from a first type of authenticated user of a plurality of authenticated users.

14. The method of claim 12, comprising:
providing the first set of data via a first channel; and
providing the base data set via a second channel.

15. The method of claim 12, further comprising:
receiving a request to train a new model;
determining one or more transformation tools responsive to the request to generate the new model; and
applying the determined one or more transformation tools to the base data set to generate the analytics data set.

16. The method of claim 11, comprising:
editing the base data set with a plurality of transformation tools to generate a plurality of analytics data sets, the plurality of analytics data sets differing from one another by inclusion of at least one feature;
receiving a request to access data stored by the remote computing device;
parsing the request to determine one or more responsive features;
determining analytics data sets of the plurality of analytics data sets responsive to the one or more responsive data features; and
returning the determined analytics data sets in response to the request.

17. The method of claim 16, wherein the request is a request to train a machine learning model or a request to generate a new intelligence data set.

18. The method of claim 12, further comprising:
integrating the relational dataset with the analytics data set in a third container of the remote computing system, the third container serving data to requests via a third channel.

19. The method of claim 11, wherein the second container provides data for real time analytics.

20. A non-transitory computer readable medium for managing data ingested into remote computing environments, the computer readable medium comprising computer executable instructions for:
ingesting a first set of data into a first container of a remote computing environment, the ingesting resulting in an ingested data set which is structured to comply with structural formatting of the remote computing environment;
determining a functional data model applicable to the ingested data set;
constructing, in the remote computing environment, a relational dataset by at least in part applying the functional data model to the ingested data set;
generating a base data set from the ingested data set and the relational data set and persisting the base data set in a second container of the remote computing environment, the relational data set contributing to the base data set via one or more tools for accessing relational databases; and
returning at least some of the base data set to in response to user requests to access enterprise data.
